(19) United States
(12) Patent Application Publication
(10) Pub. No.: US 2005/0198567 A1
(43) Pub. Date: Sep. 8, 2005

(54) Web navigation method and system

(76) Inventors: Bert Martin Vermeulen, Cheyenne, WY (US); John Thomas Kucera, Palo Alto, CA (US)

Correspondence Address: Bert Vermeulen;c/o Henry, Waters & Associates, Inc., 4740 Table Mesa Drive, Boulder, CO, 80305, US

(21) Appl. No.: 10/767,903

(22) Filed: Jan. 29, 2004

(51) Int. Cl. G06F 17/21; G06F 15/16; G06F 17/24

(52) U.S. Cl. 715/513; 709/219

(57) ABSTRACT

Computer-readable data (150) is imported into a known component such as an electronic spreadsheet program (201), hierarchically structured (203), and saved in comma-separated values (CSV) format (204). The resulting URL link file (111), a web navigation presentation program (110) and an initiating file (109) are made accessible to a web browser (101) to create a web navigation system, making it possible to create an autonomously-alterable navigation web page (127) without the complexity of creating a special-purpose data conversion tool (401) and without the time required to manually re-enter (403) the computer-readable data (150).

### BACKGROUND OF THE INVENTION

1. Field of Invention

The present invention relates to the field of internet technology. Specifically, the present invention relates to a method and apparatus for processing a hierarchically-structured collection of URLs (Uniform Reference Locators) in a web browser so that the display of this collection can be altered in response to user input without the web browser requesting additional data. A web-browser-generated user-alterable hierarchical URL indicator display element is called a web navigation element because it allows an internet user to “navigate” through web-browser-presentable information by requesting one of the indicated URLs. A computer program that operates in a web browser and generates a user-alterable display element from a hierarchical collection of URL indicators is called a web navigation presentation program. If the information presented by the user-alterable display element can be altered in response to user input without the web browser requesting additional data, the web navigation element is an autonomously-alterable web navigation element and a web page containing such an element is called an autonomously-alterable navigation web page. Typical ways of interacting with a web navigation element include clicking on a URL link or moving a cursor over some part of the web navigation element. The present invention relates to a simple method and system for creating such an autonomously-alterable navigation web page.

2. Background of the Invention

The internet contains billions of web pages and millions more are created daily. This content proliferation complicates finding the specific information most relevant to a particular inquiry. Search engines such as that found in Google™ address the information finding issue by allowing one to request all web pages that reference a particular keyword or search term.

Hierarchical collections of links to URLs are an alternative tool for finding information. In this context:
Hierarchical means having more than one level—for example, multiple levels of categories, subcategories, or elements.
A URL is a Uniform Reference Locator which represents the address for a piece of computer-readable information that is used by a web browser. Examples include “http://www.yahoo.com”, “filename.html”, and “http://192.168.0.1/data.php?n=ed”.
A link is a URL indicator. More specifically, a link is the text or graphics on a computer that can be clicked on or moved over using a mouse and/or a cursor to request computer-readable information specified by a URL.
A web browser is code running on a computer that accesses information of the type found on the World-Wide Web. Examples of web browsers include Microsoft Internet Explorer, Mosaic, Netscape, and Opera.

The Open Directory Project, which can be seen at http://www.dmoz.org, is an example of a hierarchical URL link collection. The Open Directory Project categorizes millions of websites. The Open Directory Project is also used by Google™ as their “Directory” element. By clicking to successive subcategories in the Open Directory, one can “drill down” to a specific website. Other examples of web-oriented tools that present links to URLs in a hierarchical fashion are:
site maps that present links to the pages available on a website;
multi-level website menus that expand as one moves a mouse over a category heading;
on-line catalogs in which one successively selects from a hierarchy of categories and subcategories to find a desired product; and
web-based industry directories that provide similar functionality to a yellow page telephone directory.

There are easy-to-use non-browser-based tools for presenting hierarchical information on a standalone computer, some examples of which are:
Microsoft® Windows Explorer which presents a hierarchy of files stored in subdirectories as expandable tree with folders that can be opened or closed to represent the subdirectories and graphic images with text labels to represent the files. The information hierarchy used by the Microsoft® Windows Explorer expandable tree is created automatically as one saves files on the computer. Similar products for other operating systems include iMac® Explorer for the Apple MacIntosh and Linux KDE Explorer for the Linux operating system.
The folder list tree for organizing email in Microsoft® Outlook, which also presents a hierarchy of folders into which email messages can be placed.

The message list in Microsoft® Outlook, which has columns of information and allows the user to sort by “From”, “Subject”, “Received” by clicking on the cell at the top of this column containing the appropriate word. By clicking on categories in a successive fashion, it is possible to create a list that is sorted by multiple categories: by “From”, then by “Received”, then by “Subject”, for example. This type of information presentation tool is called a data grid.
The tree-table used by Microsoft® Project which combines the functionality of a list tree such as that Microsoft® Windows Explorer and a data grid such as that found in Microsoft® Outlook. Microsoft® Access also has a tree-table, but in a slightly different format.
The pull-down menus in most desktop computer applications. For example, the version used in Microsoft® Word allows one first to pull down “Insert”, then move to “Picture”, then click on “From File” and then choose a specific file to be inserted.

It is known to present hierarchically-structured URL links in a web browser in the form of a user-alterable display element that looks and functions similarly to the folder list tree in Microsoft® Windows Explorer or Microsoft® Outlook folder list tree, the data grid in Microsoft® Outlook, the tree-table in Microsoft® Project, the pull-down menus in most standalone computer applications, or other forms or combinations of trees, hierarchical pull-down menus, tab panels, data grids, selection boxes, etc. It is also known for such web navigation elements to be autonomously-alterable—i.e. to have the ability to expand, contract or otherwise change the display of URL indicators without the web browser needing to request or receive additional data. It should be understood that some of these autonomously-alterable web navigation elements are partly autonomously-alterable—i.e. part of the URL indicator data is loaded initially and other parts of the URL indicator data that is not immediately needed by the web navigation element is not requested by, or supplied to, the web browser until required for displaying the web navigation element in a particular form. The terms autonomous and autonomously should be understood to include partly-autonomous and fully-autonomous operation.

A client-side program execution engine is computer code that runs inside a web browser. A web navigation presentation program is computer code that runs inside a web browser and works with a client-side program execution engine to generate a user-alterable display element from a hierarchical collection of URL indicators. Examples of client-side program execution engines include:
JavaScript engines which read computer code written in JavaScript. JavaScript is an open source scripting language supported on most web browsers. JavaScript is also referred to as ECMAScript or JScript. Examples include JavaScript 1.0 (which shipped with Netscape 2.0), JavaScript 1.5 (which ships with Netscape 6.0), and JScript 5.5 (which ships with Microsoft Internet Explorer 5.5 and 6.0). The combination of HTML (HyperText Markup Language) and JavaScript is sometimes called dynamic HTML (DHTML). Thus, a DHTML page is a web page that includes JavaScript.
Java engines which read computer code written in Java, an object-oriented, platform-independent, multithreaded programming language developed by Sun Microsystems. Examples of client-side Java engines are Java 1.0, J2ME, and J2SE.
Flash engines which use a web browser plug-in program sold and supported by Macromedia. Flash is also known as FutureSplash and Shockwave. Flash engines include products that can be programmed using a language called ActionScript. Flash MX 2004 and its predecessors are examples of Flash engines.

The following are examples of known methods and systems for creating an autonomously-alterable navigation web page:
Hard-coding hierarchically-structured URL link data into an HTML file (or files). An example would be an HTML file containing JavaScript code that generates the web navigation element without using any other data.
Hard-coding hierarchically-structured URL link data into a program file (or files) initiated by an HTML file. An example would be an HTML file that calls JavaScript code containing hierarchically-structured URL link data.
Hard-coding hierarchically-structured URL link data into an HTML file (or files), but using a separate program file (or files) initiated by the HTML file (or files) to read the hierarchically-structured URL link data. An example would be an HTML file (or files) which includes variable values to define the hierarchical structure and which calls JavaScript code to create an autonomous web navigation element using the variable values in the HTML file (or files).
Placing hierarchically-structured URL link data in a separate file (or files) called by an HTML file (or files). An example would be an HTML file (or files) containing JavaScript code that uses a separate data file (or files) containing the hierarchically-structured URL link data.
Placing hierarchically-structured URL link data in a separate file (or files) called by a program that is initiated by an HTML file (or files). An example would be an HTML file (or files) that calls a JavaScript program that uses a separate data file (or files) containing the hierarchically-structured URL link data.

Without the present invention it is time-consuming and/or complex to create the hierarchically-structured URL link data in a format that can be used to generate the autonomously-alterable web navigation element needed as part of an autonomously-alterable navigation web page. This is especially the case when a large number of URL links need to be hierarchically structured.

Because of the time and complexity required most large websites lack a good, easy-to-use web navigation element. This lack of a good, easy-to-use web navigation element results in website visitors having difficulty finding (and therefore often not finding) the information existing on a website or on some other part of the internet that best fits their inquiry. Keyword search methodologies such as that in Google™ have limitations such as (i) the keywords attempted by the website visitor are synonyms of the keywords used by the website developer and therefore a keyword search will not produce the information sought by the visitor and (ii) the website visitor has trouble specifying in words exactly what he/she is seeking and therefore would rather scan through categories of items to get ideas.

It is time-consuming and/or complex to create large hierarchically-structured URL link collections in a format that can be used by existing web navigation presentation programs because the prior art has been designed for (i) web navigation elements having a small enough number of links that manual data entry of the hierarchical URL link data is acceptable or for (ii) web navigation elements having a large number of links that will be designed by someone with computer programming expertise who can write a special-purpose data conversion tool to automatically convert data that is already in electronic form to a format that can be read by a web navigation presentation program (navigation program). Specifically, existing web navigation presentation programs lack the ability to read hierarchical URL link data in a third-party data management software direct output format—i.e. existing web navigation methods and systems have limitations such as:
(a) requiring hard-coded URL link data that needs additional code (such as parameter tags, parameter descriptions, or operators) between data values;
(b) requiring data values to be separated by a value separator such as “;” or “|” that is not supported for direct output (e.g. “Save as” or “Export”) by major third-party data management software such as Microsoft® Excel;
(c) requiring some data values to be separated and/or enclosed by more than one data value separator, such as requiring both a space and a quotation mark to separate two values in the URL link data, a format that is not supported for direct output by major third-party data management software such as Microsoft® Excel;
(d) requiring different value separators and/or value enclosure characters for some values than for others (i.e. requiring text to be enclosed by quotation marks and requiring that numbers not be enclosed by quotation marks), a format that is not supported for direct output by major third-party data management software such as Microsoft® Excel, Star Office (from Sun Microsystems), or Microsoft Access; and/or
(e) allowing the import of URL link data, but the URL link data that is imported is not hierarchical URL link data.

Because of these limitations, the author of an autonomously-alterable navigation web page must either (i) manually enter the hierarchical URL link data, (ii) manually convert the hierarchical URL link data to a format that has the correct value separators, (iii) use an existing special-purpose program to convert the hierarchical URL link data, or (iv) write his/her own special purpose program to convert the hierarchical URL link data. Manual data entry is acceptable if the number of URLs in the hierarchical URL link data set is small, but becomes unacceptable if many URLs need to be hierarchically structured. It is also time-wasting to re-enter data if the same URLs will be indexed in several different ways. When manual data entry is too time-consuming, the alternative is to substitute complexity by using (and typically writing) a special-purpose data conversion tool. Because not everyone can create a special-purpose data conversion tool (such as a database report generating tool or a program written in languages such as Microsoft® Visual Basic, C, Perl, Java, or PHP) large websites are poorly indexed and, in general, it is more difficult to find information on the internet.

Electronic spreadsheet programs such as Microsoft® Excel or Star Office from Sun Microsystems are easy-to-understand third-party data management software applications (i.e. known data management components) that don't require programming or any special-purpose data conversion tools for computer-literate non-programming-skilled people to organize, create, manage, and sort information. Among the operations that spreadsheet users can perform without programming and without significant manual effort are entering a header record row of data, using the “Data” “Sort” functions, inserting rows and columns, and cutting/copying/pasting data. Spreadsheet programs also provide the ability to import computer-readable data in different formats, making it easy to automatically input pre-existing data that is in electronic form. Because of these capabilities, people use electronic spreadsheets to organize all kinds of information, which they can then sort, view, email, and print in whatever way they desired. Among the operations that many spreadsheet users cannot perform are programming related operations requiring the use or creation of programming code such as macros or programs written in Microsoft® Visual Basic for Applications (VBA), a type of Visual Basic.

It is known to save an electronic spreadsheet as a web page. However the display of the resulting published electronic spreadsheet cannot be altered in response to user input in a web browser. Instead, a web user must purchase the same spreadsheet software program before he or she can alter the display of the spreadsheet. Prior to the present invention, it was not known to directly convert the information in a electronic spreadsheet into hierarchical URL link data that could be directly read by a web navigation presentation program to create an autonomously-alterable web navigation element on a web page.

CSV, which stands for comma separated values, is one of the file formats that is directly supported by major electronic spreadsheet software (such as Microsoft® Excel and Star Office from Sun Microsystems) for both input (opening or importing) and output (saving or exporting) of data. CSV is also supported for input and output by database software such as Microsoft® Access and many other database programs. In a CSV file, the alphanumeric (typically ASCII, but other character sets such as Unicode are also supported) values in the cells in each row of the spreadsheet are saved in a file where each row is a line (also called a record by people familiar with databases) and the content of each cell (often called a value or field) is separated from the content of adjacent cells by a comma. Because of its simplicity, the CSV format has been broadly adopted as an interchange standard between spreadsheets, databases, text files, and other types of computer programs. Tab-separated values and space-separated values files are also supported for direct output by many software applications such as Microsoft® Excel, Star Office, and Microsoft® Access, but these formats have greater limitations because:
Space-separated values files have difficulty working with multi-word values (e.g. values that contain spaces).
Tab-separated values files have difficulties because not all text-processing application software (which might be used to do a minor edit to a data file) work with tabs in the same way.

To summarize, it is not known to create an autonomously-alterable web navigation element by simply reading third-party data management software direct output formatted hierarchical URL link data into a web navigation presentation program.

### SUMMARY OF THE INVENTION

It is therefore an object of the present invention to provide a fast and simple method and system that can be used by people without computer programming skills or interest to generate an autonomously-alterable navigation web page, i.e. a web page that includes an autonomously-alterable web navigation element.

Accordingly, the present invention can be used to create an autonomously-alterable web page without manual re-entry or manual conversion of existing computer-readable data and without requiring the creation or use of a special-purpose data conversion tool. Instead the only steps required to create an autonomously-alterable web navigation element are:
hierarchically-structuring electronic URL link data a using a third-party data management application (i.e. a known component), such as Microsoft® Excel or Star Office;
saving the hierarchically-structured URL link data in a third-party data management software supported format, such as CSV; and
using a web navigation presentation program that operates in a web browser to read the saved hierarchically-structured URL link data and generate the autonomously-alterable web navigation element.

To create an autonomously-alterable web page, one creates a web browser readable code (typically in HTML) that includes a small section of special code for initiating the web navigation presentation program. This special code identifies the location of the web navigation presentation program. This special code may also identify the location of the URL link data and the location of any other data needed to generate the web navigation element.

In addition to providing simplicity and productivity by using hierarchically-structured URL link data in a third-party data management software supported format, the present invention has the following further attributes:
(a) The disclosed URL link file uses multiple data fields (i.e. multiple values) to store its hierarchical structure. This makes it possible to use the “Data” “Sort” commands in an electronic spreadsheet to automatically sort the rows of URL link data in the correct structure to be displayed.
(b) The disclosed URL link file uses a header record that specifies the type of data located in each data field (or column). This header record can be implemented in a way that all data fields, other than the field containing text to be displayed on the computer screen, can be in any order in the URL link file. This header record can also be implemented so that comments or other ignored information can be placed (i) prior to the header record and (ii) in any fields which do not use a reserved word in the corresponding header record field.
(c) The disclosed URL link file format (Comma Separated Values or CSV) is more compact than many alternatives such as hard-coding or using XML (Extensible Markup Language). As a result, the total amount of data to be downloaded (and time required to download this data) is minimized. In addition, the present invention can operate with hierarchical URL link data in a data-compressed form using industry-standard ZIP compression from third-party ZIP data management software (a known data management component), providing a further (typically 4-5×) reduction in size of the hierarchical URL link data set versus the already compact CSV format.
(d) The disclosed URL link file format makes it easy to create web navigation presentation programs using different client-side program execution engines (such as Java, JavaScript and Flash) that can read the same URL link file format to generate a web navigation element.
(e) The present invention works in all major operating systems and can work with known third-party software designed for all major operating systems.

### BRIEF DESCRIPTION OF THE DRAWINGS

In the accompanying drawings:

FIG. 1 shows a web navigation system.

FIG. 2 shows a typical prior art method for authoring an autonomously-alterable navigation web page.

FIG. 3 shows a simple method for authoring an autonomously-alterable navigation web page using the present invention.

FIG. 4 shows a method for authoring an autonomously-alterable navigation web page that further includes a style file and data compression.

FIG. 5 shows a method for interacting with an autonomously-alterable navigation web page.

FIG. 6 shows a method for starting and generating an autonomously-alterable navigation web page in a web browser.

FIG. 7 shows hierarchically-structured data in an electronic spreadsheet program.

FIG. 8 shows a URL link file in comma-separated-values format.

FIG. 9 shows a client-side program execution engine initiating HTML file.

FIG. 10 shows a style file.

FIG. 11 shows a autonomously-alterable navigation web page generated on a computer screen.

FIG. 12 shows a sample autonomously-alterable navigation web page after clicking a navigation element manipulator.

FIG. 13 shows a sample autonomously-alterable navigation web page after clicking a second navigation element manipulator.

FIG. 14 shows a computer screen after clicking a navigation element link that generates a pop-up browser window.

### DESCRIPTION OF THE EMBODIMENTS

This invention is described in a preferred embodiment in the following description with reference to the Figures, in which like numbers represent the same or similar elements or process steps. While this invention is described in terms of the best mode for achieving this invention's objectives, it will be appreciated by those skilled in the art that variations may be accomplished in view of these teachings without deviating from the spirit or scope of the present invention. For example, the present invention may be implemented using any combination of computer programming software, firmware, or hardware. As a preparatory step to practicing the invention or constructing an apparatus according to the invention, the computer programming code (whether software or firmware) according to the invention will typically be stored in one or more machine readable storage devices such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc., or by transmitting the code according to the present invention with appropriate standard computer hardware to execute the code contained therein. An apparatus for practicing the invention could be one or more computers and storage systems containing or having network access to computer program(s) coded in accordance with the invention.

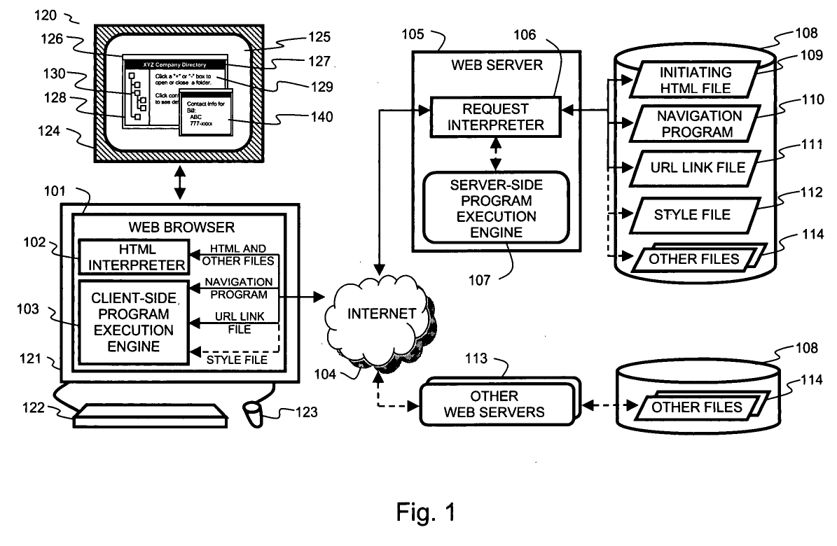

FIG. 1 shows a web navigation system. Referring to FIG. 1, a web server is shown at 105. A client computer, shown at 120, is connected to the web server 105, over the internet, shown at 104. The web server 120 has access to a machine readable storage device, shown at 108. There may be other web servers, shown at 113, attached to the internet 104 and these other web servers 113 may also have access to their own storage devices 108. The web server 105 includes a request interpreter, shown at 106, that receives requests for files from client computers 120 or other web servers 113, retrieves these files from a machine-readable storage device 108 or multiple machine readable storages devices 108 and then transmits these files to the client computer 120 that requested them. Some of the files retrieved by the request interpreter 106 may include server-side programming commands, that can be written in any of a number of different programming languages like Perl, C, server-side Java, PHP, server-side JavaScript, etc. The request interpreter 106, separates these server-side programming commands and sends them to one or more optional server-side program execution engines, shown at 107. Although FIG. 1 shows the client computer 120 connected to the web server 106 over the internet 104, it is also possible to create an autonomous client-side navigation system where the client computer 120 and web server 106 are connected over a different type of network or are directly connected together. It is also possible to have a web navigation system wherein the web server 106 and/or the machine-readable storage device 108 or devices 108 are part of the client computer 120. The configuration where the web server 106 is part of the client computer occurs 120 when one accesses the web server on a local machine (i.e. the client-computer 120).

The client computer 120 typically includes and communicates with: a monitor, shown at 124; a central processing unit, shown at 121; a keyboard, shown at 122; and a mouse, shown at 123. A web browser, shown at 101, operates in the central processing unit 121 to generate a browser window, shown at 126, on a computer screen, shown at 125, of the monitor. The web browser 101 can also open one or more additional or popup browser windows, shown at 140, on the computer screen 125. In the present invention, the browser window 126 includes an autonomously-alterable navigation web page, shown at 127. The autonomously-alterable navigation web page 127 includes a navigation element display area, shown at 128, wherein a web navigation element, shown at 130, is displayed. The autonomously-alterable navigation web page 127 may also include an HTML display area, shown at 129, wherein web content that is written in Hyper-Text Markup Language (HTML) is displayed.

The web browser 101 includes an HTML interpreter, shown at 102, that generates a web page from a file written in Hyper-Text Markup Language (HTML). The web browser 101 also typically includes one or more client-side program execution engines, shown at 103. A client-side program execution engine 103 is a part of the web browser 101 that has the capability of reading client-side programs written in programming languages such as client-side JavaScript, client-side Java (typically called an applet), and ActionScript (used with Flash) and generating a display as part or all of a browser window 126 based on the contents of this client-side program, either independently or by working closely with the HTML interpreter 102. In the preferred embodiment of the web navigation system, the client-side program execution engine 103 is invoked by an initiating HTML file, shown at 109. The client-side program execution engine 103 then reads a web navigation presentation program, shown at 110. The client-side program execution engine 103 and web navigation presentation program 110 then read a URL link file, shown at 111 to generate the web navigation element 130 on the autonomously-alterable navigation web page 127.

In the embodiment described here, the URL link file 111 is in the form of a CSV (comma separated values file). CSV is an efficient industry-standard file format that can be used to exchange data between spreadsheets, databases, text files and various other types of application software. The term CSV file should be understood to include any character-based file in which data elements (also called values, records, columns, or cells) are separated by commas and groups of data elements are stored on sequential lines separated by a carriage return character. The term CSV file also should be understood to include files in a comma-separated-values format that have subsequently been encoded Examples of encoding methods include conversion to binary format, data compression, and encryption for security.

The client-side execution engine 103 and web navigation presentation program 110 may also read a style file, shown at 112 that can contain additional information regarding how the web navigation element 130 is to be displayed. There may be other files, shown at 114, used to generate the autonomous client-side navigation system.

The term internet should be understood in its broad meaning to include any network that uses an internet protocol. By this, internet is also meant to include intranet configurations in which all computers are within one company's firewalls and intranet is meant to include extranet configurations in which web browsers are only allowed to see particular web content if they have been authorized, typically by having a user name and a password.

It should be understood that the term web is not restricted to content that is visible on the public World Wide Web. The term web should be interpreted as any content that can be displayed in a web browser.

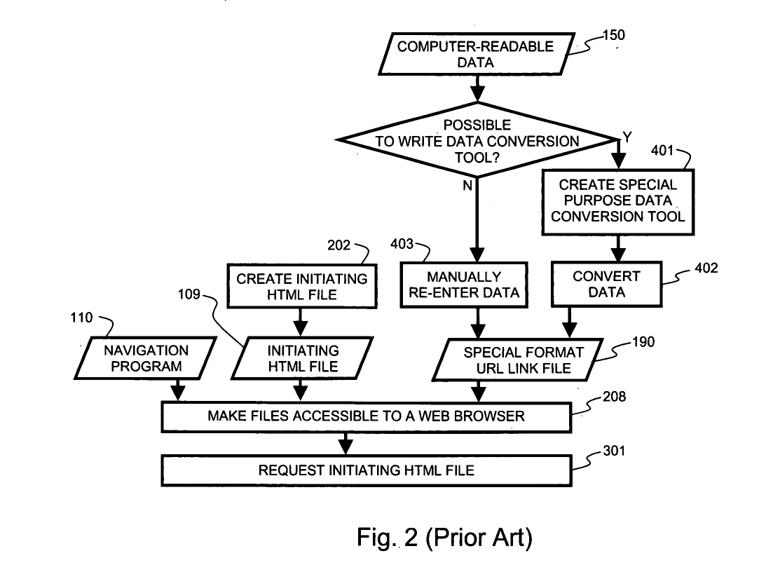

FIG. 2 shows the typical prior art method for authoring an autonomously-alterable navigation web page (127 in FIG. 1). Referring to FIG. 2, the web navigation presentation program 110 and the initiating HTML file 109 discussed in relation to FIG. 1 are also part of the prior art method. Both the prior art and the present embodiment employ a web navigation presentation program 110 that the author of an autonomously-alterable navigation web page (127 in FIG. 1) can acquire “off-the-shelf.” Because the initiating HTML file 109 will be different for every autonomously-alterable navigation web page (127 in FIG. 1) that is authored, the developer of an autonomously-alterable navigation web page goes through a step of creating an initiating HTML file, shown at 202. The prior art requires a special format URL link file, shown at 190. In most cases, the information needed for creating the special format URL link file 190 already exists as computer-readable data, shown at 150. However, the process of converting this computer-readable data 150 either requires a step of manually re-entering the data, shown at 403, or a step of creating a special purpose data conversion tool, shown at 401, and a data conversion step, shown at 402, in which the computer-readable data 150 is converted using the special purpose data conversion tool 401.

A special purpose data conversion tool 401 is typically a computer program that converts data written in one format into data written in another format. Manual data entry 403 is acceptable if the number of items in the web navigation element (130 in FIG. 1. ) is small but becomes unacceptable if the number of items in the web navigation element becomes more than about one hundred, a situation that is typical of many autonomously-alterable navigation web pages (127 in FIG. 1.) Creating a special purpose data conversion tool 401 is beyond the capabilities of many people who want to create an autonomously-alterable navigation web page (127 in FIG. 1). The final step in the prior art authoring process is a step of making the web navigation presentation program 110, the initiating HTML file 109, and the special format URL link file 190 accessible to a web browser, shown at 208. A user will see an autonomously-alterable navigation web page (127 in FIG. 1) if this user requests the initiating HTML file, which is shown as step 301. The step of requesting the initiating HTML file 301 is not needed for the authoring process (the author is finished when the book is written), but has been illustrated here to show how the autonomously-alterable navigation web page (127 in FIG. 1) will be generated on the client-computer (120 in FIG. 1.) The user must request the initiating HTML file 301 using a web browser (101 in FIG. 1.)

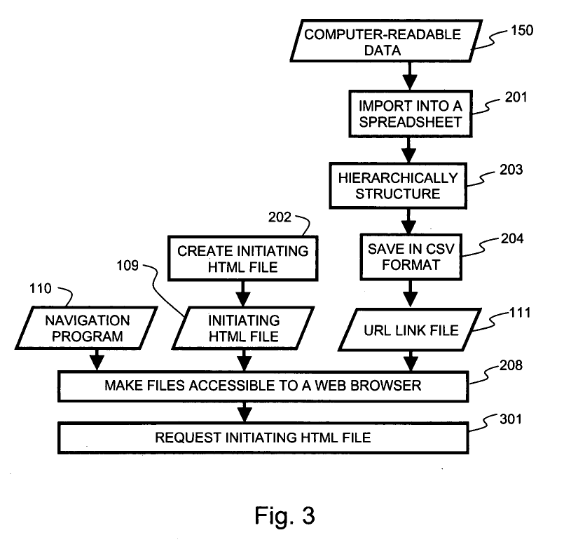

FIG. 3 shows a simple method for authoring an autonomously-alterable navigation web page using the present invention. Referring to FIG. 3, the step of creating an initiating HTML file 202, the step of making files accessible to a web browser 208, and the step of requesting an initiating HTML file 301 are the same steps as were shown in FIG. 2. However, the format and structure of the navigation program 110 and initiating HTML file 109 are different from the equivalent navigation program 110 and initiating HTML file 109 shown in FIG. 2 in that the navigation program 110 and initiating HTML file 109 of FIG. 3 are designed to work directly with the fixed format of the URL link file, shown at 111 that was also discussed in reference to FIG. 1. Working with the fixed format of the URL link file should be understood as meaning that the URL link file 111, that was directly saved from a known component (such as Microsoft® Excel), can be utilized in an unaltered state by the navigation program 110. state. By using a direct third-party software output URL link file 111 in its fixed (i.e. unaltered) state, it becomes possible to the convert computer-readable data, shown at 150 and previously discussed in reference to FIG. 2, without needing to resort to manual data re-entry (403 in FIG. 2) or a special purpose data conversion tool (401 and 402 in FIG. 2). Instead, the present invention incorporating a URL link file 111, allows one to complete the conversion process using only the steps of: importing computer-readable data into a known component, shown at 201; hierarchically-structuring data, shown at 203 and saving the hierarchically-structured data in a format supported by this known component, an example of which (saving in CSV format) is shown at 204. A known component can be any computer-based tool that allows one to work with computer data. Often these known computer-based tools take the form of third-party software. Electronic spreadsheets are an example of a known component that is also a third-party software. More specifically, electronic spreadsheets are a type of third-party data management software. Database software is another example of a type of third-party data management software. These steps (201, 203, and 204) are much faster and easier to perform than the steps (403 or 401 and 402) required by the prior art.

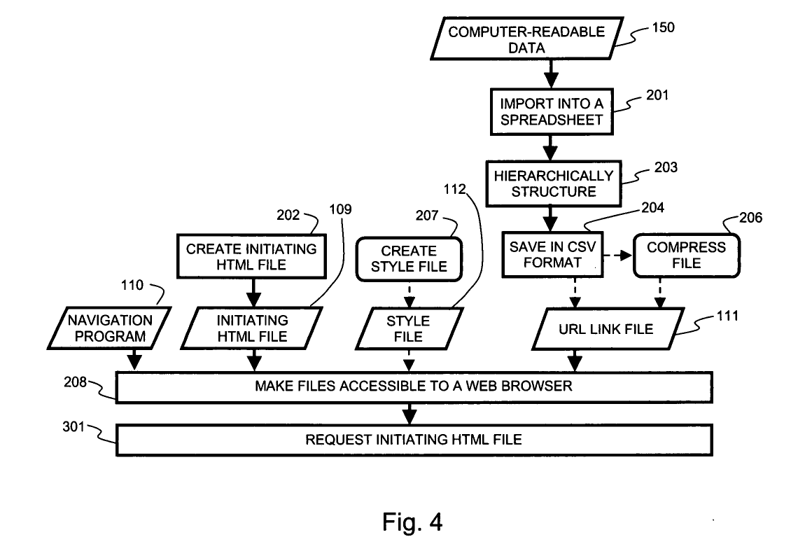

FIG. 4 shows a method for authoring an autonomously-alterable navigation web page that further includes a style file and data compression. FIG. 4 includes all of the steps identified in FIG. 3. It also includes the optional step of creating a style file, shown at 207, and then making this style file, shown at 112, accessible to a web browser, part of step 208. A style file can be used to provide how the web navigation element is to be displayed. Examples of uses of a style file when used with a web navigation element include: specifying background color; specifying font sizes, font styles, and font colors; and specifying any graphic images to be used with this web navigation element to customize its “look and feel.” FIG. 4 also shows an additional optional step of compressing a file, shown at 206. If the URL link file 111 is large in uncompressed form, data compression using any of the many types of compression algorithms known in the art can be used to reduce the total size of the files to be transferred over the internet to a web browser, thereby reducing download time and improving system performance.

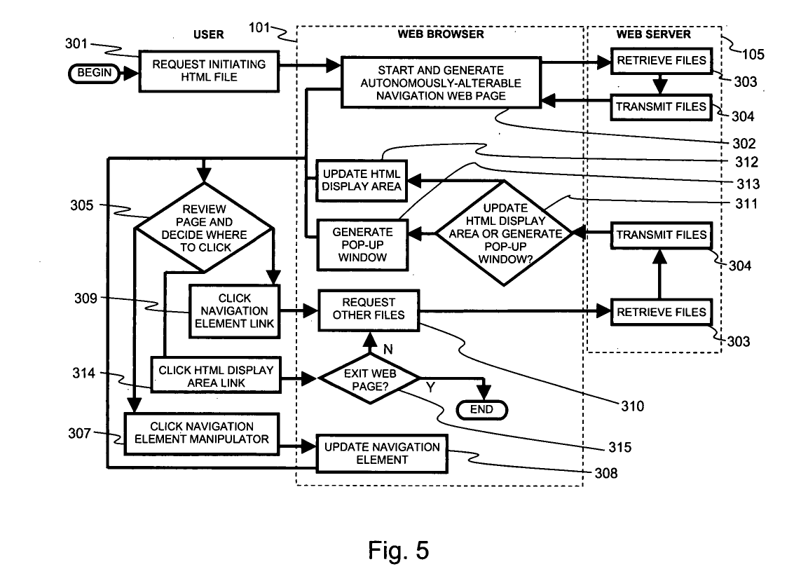

FIG. 5 shows a method for interacting with an autonomously-alterable navigation web page. FIG. 5, begins with the step of requesting the initiating HTML file 301, which was the final step shown in FIG. 2, FIG. 3, and FIG. 4. A request by a user for an initiating web page 301, causes the web browser 101 to take the step of starting and generating the autonomously-alterable navigation web page, a step shown at 302. This step 302 requires the web browser to request files from the web server 105, which then retrieves these files, shown at 303 and transmits them, shown at 304.

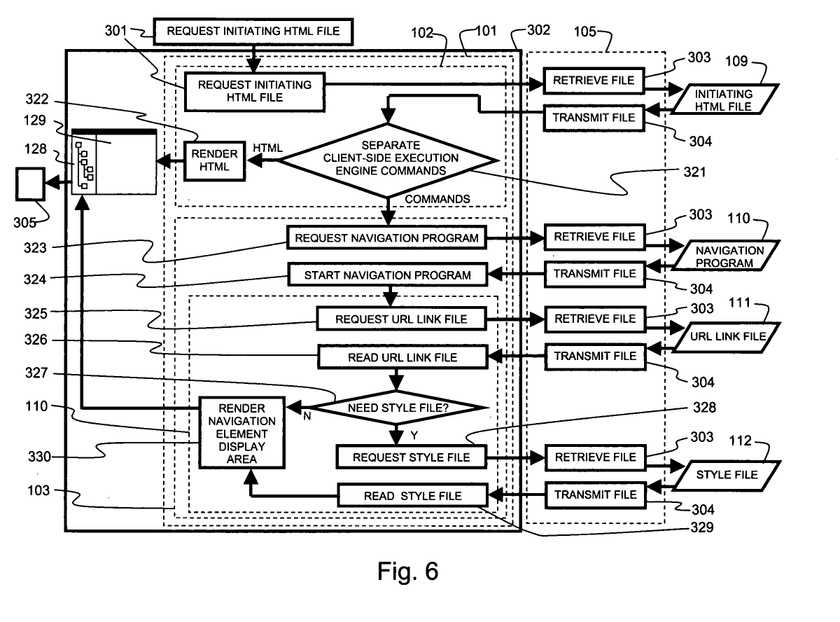

FIG. 6 shows a method for starting and generating an autonomously-alterable navigation web page in a web browser 101 and using a web server 105. FIG. 6 is a more detailed view of step 302, step 303 and step 304 from FIG. 5. Referring to FIG. 6, a request for an initiating HTML file 301 from the user to the web browser by typing in the file name or clicking on a link on another web page is passed on by the web browser 101 to the web server 105, which then retrieves 303 and transmits 304 the initiating HTML file 109. The HTML interpreter 102 then separates out the client-side execution engine commands, a step shown at 321, sending these commands to the client-side program execution engine 103. The remaining HTML is rendered (i.e. the HTML display area is generated), a step shown at 322, in the HTML interpreter 103 and sent to the HTML display area 129 that is part of the autonomously-alterable navigation web page, 127 in FIG. 1.

The client-side program execution engine commands cause the client-side program execution engine 103 to request the web navigation presentation program 110, shown at process step 323, and the web server 105 to retrieve 303 and transmit 304 the relevant file or files 110. The next step, shown at 324 is to start the navigation program in the client-side program execution engine 103. Then, the URL link file 111 is requested, shown at 325, retrieved 303, transmitted 304, and read, shown at 326. Based on the files provided to it, the client-side program execution engine 103 then decides whether a style file is needed, shown at step 327. If the answer to step 327 is yes, the style file or files 112 are requested, shown at step 328, retrieved 303, transmitted 304 and read, shown at step 329. All of the information provided to the client-side program execution engine 103 is then used to render the navigation element display area, shown at step 330, which creates the navigation display area shown at 128 that is part of the autonomously-alterable navigation web page 127 in FIG. 1.

It should be noted that in some cases, not all of the navigation program file(s) 110, URL link file(s) 111 or style file(s) 112 are requested, retrieved 363, transmitted 304, or read before the navigation element display area 128 is rendered in an autonomously-alterable navigation web page. For example, in some cases a process called “lazy loading” is used in which part or all of some files that are not initially needed are not retrieved 303 or transmitted 304 in order to reduce the time before the user can see and interact with the autonomously-alterable navigation web page 127 in FIG. 1.

It should be understood that the term autonomous encompasses all systems and methods in which the displayed characteristics of a web navigation element can be wholly or partially transformed in its appearance without the user or the web browser needing to request a new enabling HTML file.

Referring back to FIG. 5, once the autonomously-alterable navigation web page has been started and generated 302, the user can review the page and decide where to click, a step shown at 305. In the present embodiment the choices available include clicking a navigation element link, a step shown at 309, clicking on an HTML display area link, a step shown at 314 and clicking on a navigation element manipulator, a step shown at 307.

If the user clicks on a navigation element manipulator 307, the web browser updates the web navigation element, a step shown at 308. Updating the web navigation element 308 should be understood to mean that the appearance or displayed links of the web navigation element 130 in FIG. 1 are modified. This modification of the appearance or displayed links occurs without a new web page being requested, retrieved or transmitted. Then, the system again waits for a decision and action from the user, who can review the new version of the web page and decide where to click 305.

If the user clicks a web navigation element link 309, the web browser requests the other files, a step shown at 310, which are then retrieved 303 and transmitted 304 by the web server 105. The web browser then reads and interprets the files as shown in step 311. If the files are a request to update the HTML display area, the web browser updates the HTML display area, a step shown at 312. If the files are a request to generate a pop-up window, the web browser opens a new browser window, the step shown at 313. Once step 312 or step 313 has completed, the system again waits for a decision and action from the user, who can review the new version of the web page and decide where to click 305.

If the user clicks an HTML display area link, the response from the web browser depends upon whether the link clicked includes a request to exit the web page, a decision step shown at 315. If the link clicked includes a request to exit the web page 315, then the web browser leaves the autonomously-alterable navigation web page (127 in FIG. 1) and the process ends. If the link clicked does not include a request to exit the web page, then the web browser requests the other relevant files, a step shown at 310 and the same process is followed as the process that occurs if the user clicks a navigation element link 309.

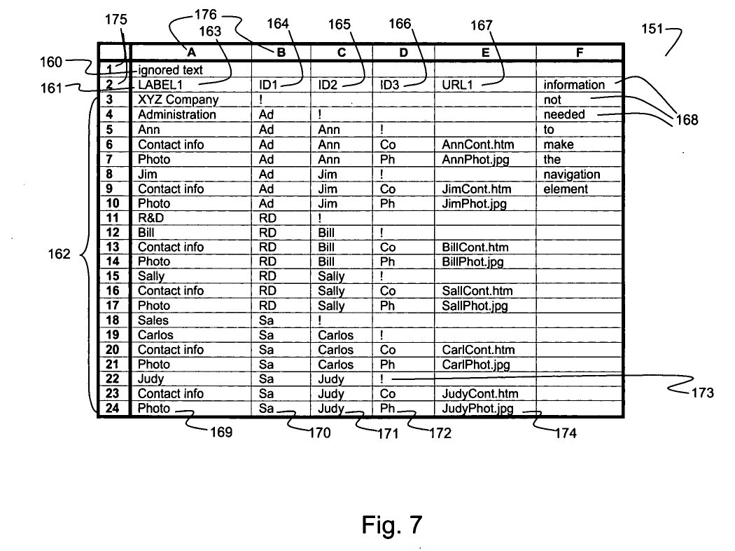

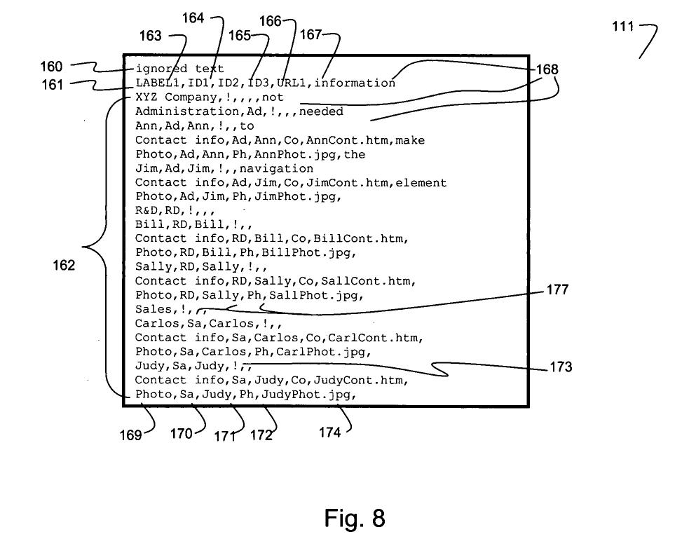

FIG. 7 shows hierarchically-structured data in an electronic spreadsheet program. The hierarchically-structured data is shown at 151. The hierarchically-structured data 151 is the output from step 203 in FIG. 3 or FIG. 4. FIG. 8 shows a URL link file in comma-separated values format. The URL link file is shown at 111. The URL link file 111 is the output from step 204 in FIG. 3 or FIG. 4. The URL link file 111 is also discussed in FIG. 1, FIG. 3, FIG. 4 and FIG. 6. For ease of understanding, the URL link file 111 contains the same information that is included in the hierarchically-structured data 151 and was created by saving a file in an electronic spreadsheet program as a CSV file.

The hierarchically-structured data 151 is in the form of a grid of horizontal rows and vertical columns. Row identifiers, shown at 175 are visible to the left of the data. In most electronic spreadsheet programs the row identifiers 175 are sequential numbers. Column identifiers, shown at 176, are visible above the data. In most electronic spreadsheet programs, the column identifiers 176 are sequential letters. The URL link file 111 in (FIG. 8) does not include these row identifiers 175 or column identifiers 176 because they are generated by the electronic spreadsheet program and do not have information that is needed by other software applications.

The preferred embodiment includes a header record, shown at 161 in FIG. 7 and FIG. 8. In the embodiment shown here, the header record 161 is the row of cells (in FIG. 7) or line of text (in FIG. 8) that starts with the word “LABEL1” in all capitals. By using a unique reserved word to start the header record 161, it is possible to use the header record 161 to identify different types of information that are stored in the hierarchically-structured data 151 or URL link file 111. In the preferred embodiment, the web navigation presentation program (110 in FIG. 1 through FIG. 4 and FIG. 6) will ignore any information that precedes the header record 161. Thus, ignored records, shown at 160, can be combined with a header record 161 and node records, shown at 162 in the same hierarchically-structured data 151 or URL link file 111.

The header record 161 is subdivided into header fields. In the hierarchically-structured data 151 the values of each header fields are presented in separate cells. In the URL link file 111 the header fields are values separated by commas. The first header field contains the reserved value “LABEL1” and is called a first label header field 163. This fixed value is used to tell the navigation program (110 in FIG. 1, FIG. 3, FIG. 4, and FIG. 6) which of the records is the header record. Subsequent header fields may contain other reserved values, which can be in any order. Among the reserved values used in the preferred embodiment are “ID1” which specifies the first hierarchical header field, shown at 164, “ID2”, which specifies the second hierarchical header field, shown at 165, “ID3” which specifies the third hierarchical header field, shown at 166, and “URL1”, which specifies the first URL (Uniform Reference Locator) header field, shown at 167. The preferred embodiment supports nine hierarchical header fields, giving the possibility of up to nine-levels of hierarchy in the hierarchically-structured data 151 and URL link file 111. The preferred embodiment also supports up to four URL header records, allowing up to four different URLs to be requested for every navigation element link that is clicked (step 309 in FIG. 5) or passed over by a cursor.

In the hierarchically-structured data 151 and in the URL link file (111 in FIG. 8) the data that follows the header record are called node records, shown at 162 in FIG. 7 and FIG. 8. Each node record is divided into fields, which are displayed as cells in the hierarchically-structured data 151. The values and sequence of these values in the header record are used by the navigation program (110 in FIG. 1, FIG. 3, FIG. 4 and FIG. 6) to determine how to interpret-the node records 162. Information located in the same sequence position in the node records as header fields that do contain a reserved value are ignored by the navigation program. Examples of such node record embedded ignored information is shown at 168. Header fields containing reserved values tell the navigation program (110 in FIG. 1, FIG. 3, FIG. 4 and FIG. 6) that the node records will contain values of the type specified by the corresponding reserved value in this same sequence position. These node record fields contain the information used by the web navigation presentation program (110 in FIG. 1, FIG. 3, FIG. 4 and FIG. 6) to generate a web navigation element (130 in FIG. 1):
A value in a node record 162 that is in the same sequence position as the first label header field 163 (i.e. at the beginning of a record) is called a first node label value, shown at 169. When used with a tree web navigation element, a first node label value 169 represents the text that will be presented on the tree. Typically, this text is the link, which when clicked will cause a URL to be requested and presented to a user. In some cases, merely moving a cursor over this text will cause a URL to be requested and presented to a user.
A value in a node record 162 that is in the same sequence position as the first URL header field 167 is called a first URL value, shown at 174. When used with a tree web navigation element, a first URL value 174 represents the URL that will be requested when a user clicks the text representing the first node label value 169 on a computer screen. The content of the requested URL will be placed in either the HTML display area (129 in FIG. 1 or FIG. 6) or in a second (pop-up) browser window (140 in FIG. 1) depending upon how the autonomously-alterable navigation web page (127 in FIG. 1) has been specified in the initiating HTML file (109 in FIG. 1 through FIG. 4 and FIG. 6) or the style file (112 in FIG. 1, FIG. 4 and FIG. 6). In the preferred embodiment, four URL values (identified as URL1, URL2, URL3, and URL4) can be specified in the header record and requested by a user of the web navigation element.
A value in a node record that is in the same sequence position as the first, second, or third hierarchical header field (164, 165 or 166 respectively) in the hierarchically-structured data 151, or URL link file 111, is called a first, second or third node hierarchy data value and is shown at 170, 171, and 172 respectively in FIG. 7 and FIG. 8. Node hierarchy data values define the way in which the hierarchy of the web navigation element is to be structured. It is possible to have only a first node hierarchy data value 170 and therefore the web navigation element would merely present a list showing all first label data values 169. However, this would make it difficult to find information. By using multiple levels of hierarchy, it is possible to categorize items and associate labels and URLs with them. It is also possible to have the same URL or node label data value stored in more than one node record. A simple example would be a web navigation element capable of displaying all the businesses in a particular town wherein URLs for information relating to these businesses are organized both alphabetically (the white pages) and by what product or service they provide (the yellow pages). In the preferred embodiment, there can be up to nine node hierarchy values (ID1 to ID9)

In the preferred embodiment, the node hierarchy data values, i.e. the data stored in the node records in the same sequence position as ID1 to ID9, can be of any ASCII character form. The values in these fields (170, 171 and 172) can be used to make it easy to group and sort a collection of URL values (174) and node label values (169). Having multiple node hierarchy data values allows the creator of a web navigation element to organize multiple levels of categories and subcategories of nodes wherein:
the parent node and all children share the same node label value at one level (e.g. ID1); and
the children have an alphabetically-ordered list of node label values at the next lower level (e.g. ID2 in this example).

By using the node hierarchy data values in this way, it is possible to use the “Data” “Sort” functions in an electronic spreadsheet to automatically sort all node records into the correct groups and sequence.

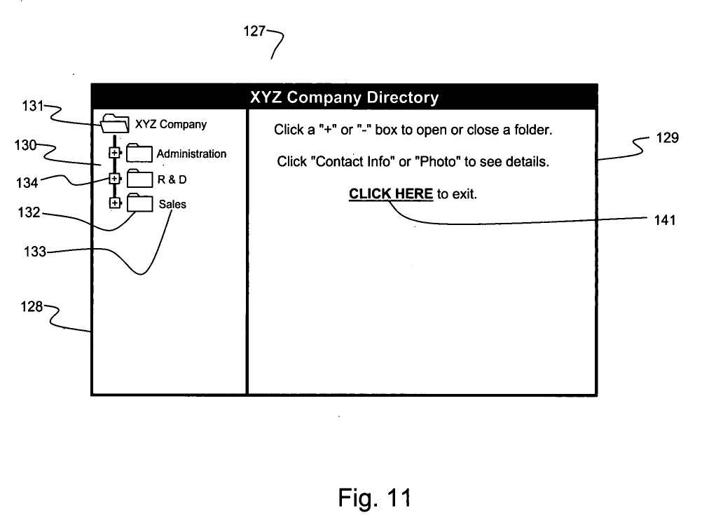

A special identification character, shown at 173, is used define which node records are the parent node records for a group. In a tree web navigation element, the parent node record of a group is typically displayed as a file folder. When the child nodes in a group are displayed, the file folder is shown as being open. When the child nodes in a group are not displayed, the file folder is shown as being closed. The process of opening or closing a file folder is accomplished by clicking a web navigation element manipulator (step 307 in FIG. 6) and is discussed in detail in the descriptions accompanying FIG. 11 through FIG. 18. In the preferred embodiment, an “!” is used as the special identification character because this character will be sorted above alphabetical and numerical characters when using the “Data” “Sort” functions of an electronic spreadsheet program, thus simplifying the process of ensuring that parent nodes will appear above their children.

Although the hierarchically-structured data 151 and the URL link file 111 formats are complex to describe, they can be created very quickly, simply, and easily with any electronic spreadsheet program. In almost all cases the first node label values 169 already exist in the computer-readable data (150 in FIG. 3, and FIG. 4) an can be imported into a known component (step 201 in FIG. 3 and FIG. 4). Often the first URL values 174 also exist in this same computer-readable data 150. The lowest-level node hierarchy values 172 in the examples shown here) can easily be created by using all or part of the text for the first label values 169. Once the node records 162 have been grouped and placed in the correct order for the web navigation element (typically by using electronic spreadsheet program “Data” “Sort” commands), a code for the higher level node hierarchy data values (i.e. the first and second node hierarchy data values, 170 and 171, in this example) can be copied and pasted. Finally, the special identification characters 173 can be added where needed and the hierarchically-structured data 151 can be saved in CSV format (step 204 in FIG. 3 and FIG. 4) to create the URL link file 111.

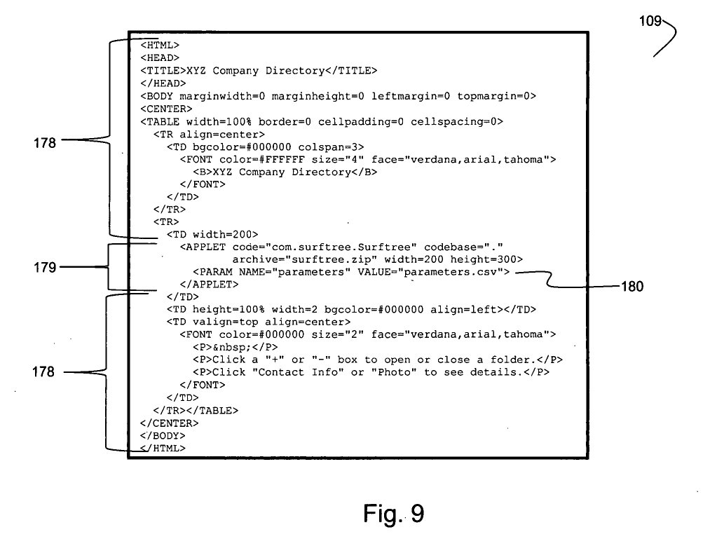

FIG. 9 shows a client-side program execution engine initiating HTML file at 109. The client-side program execution engine initiating HTML file 109 is the output from step 202 in FIG. 3 or FIG. 4. The client-side program execution engine initiating HTML file 109 is also discussed in FIG. 1, FIG. 3, FIG. 4 and FIG. 6. Referring to FIG. 9, HTML code is shown at 178. Client-side program execution engine initiating code is shown at 179. In this example, the client-side program execution engine initiating code 179 will initiate a Java client-side program execution engine 103 in FIG. 1 and FIG. 6. In this example, the client-side program execution engine initiating code 179 includes a style file identifier, shown at 180, that specifies that a style file named “parameters.csv” is to be used.

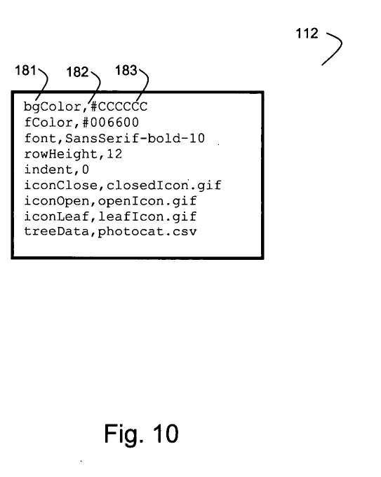

FIG. 10 shows a style file at 112. The style file 112 is the output from optional step 207 in FIG. 4 (creating a style file). The style file 112 is also discussed in FIG. 1, FIG. 4, and FIG. 6. The style file 112 includes a style parameter, shown at 181 and a style value, shown at 183. The style parameter 181 and the style value 183 are separated by a separator character, shown at 182.

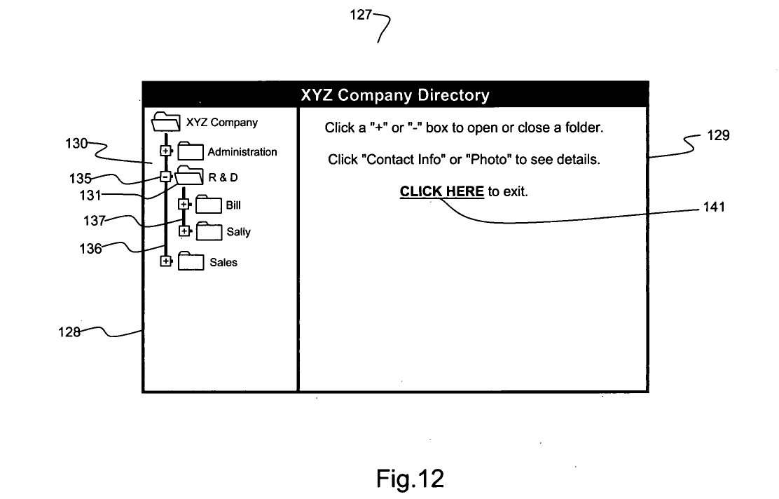

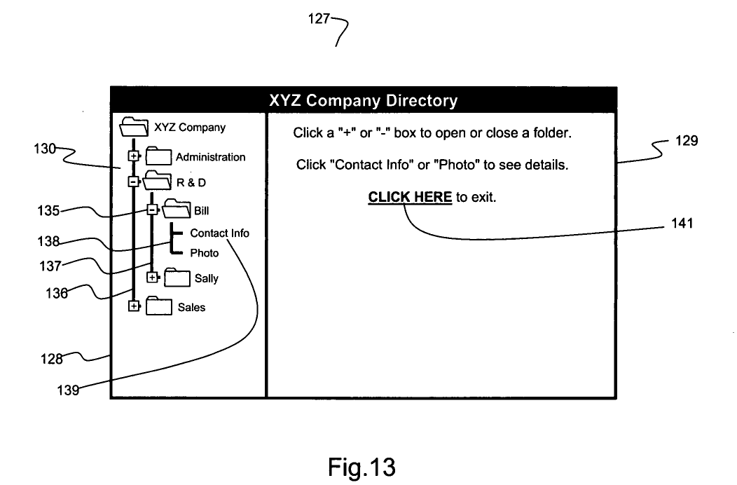

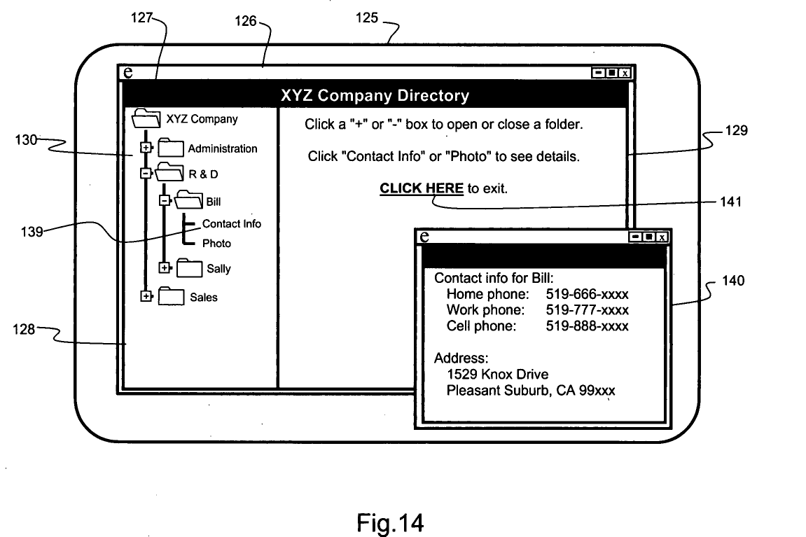

FIG. 11, FIG. 12, FIG. 13 and FIG. 14 show the autonomously-alterable navigation web page at 127. The autonomously-alterable navigation web page is generated inside the browser window (126 in FIG. 1 and FIG. 14) on a computer screen (125 in FIG. 1 and FIG. 14) on a monitor 124 in FIG. 1 on a client computer 120 in FIG. 1. The autonomously-alterable navigation web page 127 includes a navigation element display area, shown at 128 and an HTML display area, shown at 129, that were also shown and discussed with reference to FIG. 1 and FIG. 6. The HTML display area 129 includes an HTML display area link, shown at 141. Clicking the HTML display area link 141 is the same as performing step 314 in FIG. 5.

The web navigation element display area 128 includes a web navigation element, shown at 130. In this case, the web navigation element 130 is a tree. The web navigation element 130, was constructed using the client-side program execution engine initiating HTML file (109 in FIG. 1 through FIG. 4, FIG. 6 and FIG. 9), the web navigation presentation program (110 in FIG. 1 through FIG. 4 and FIG. 6), and the URL link file (111 in FIG. 1, FIG. 3, FIG. 4, FIG. 6 and FIG. 8). The web navigation element includes an open folder icon, shown at 131, a closed folder icon, shown at 132, a label shown at 133 and a web navigation element manipulator in the closed position, shown at 134. The open folder icon 131 indicates that the next level of items in the group are displayed. In this case, this is an item having a label 133 “Administration”, an item having a label 133 “R&D”, and an item having a label 133 “Sales”. The icons to the left of the labels 133 “Administration”, “R&D”, and “Sales” are closed folder icons 132 that indicate that the next level items in these groups are not displayed. Clicking on the box with the “+” in it (the web navigation element manipulator in the closed position 134) is the same as performing step 307 in FIG. 5.

FIG. 12 shows the autonomously-alterable navigation web page 127 after clicking a web navigation element manipulator in the closed position 134. Comparing FIG. 12 to FIG. 11 the web navigation element manipulator in the closed position in FIG. 11 has changed to a web navigation element manipulator in the open position, shown at 135 in FIG. 12, the closed folder icon 132 before the label 133 “R&D” has changed to an open folder icon 131, and two items in the group of items that starts with the item having the label 133 “R&D” are now visible. The web navigation element 130 now displays a first branch, shown at 136 and a second branch shown at 137. If the web navigation element manipulator in the open position 135 to the left of the label 133 “R&D” in FIG. 12 is clicked, the web navigation element would go back to the shape shown in FIG. 11.

FIG. 13 shows the autonomously-alterable navigation web page 127 after clicking a second web navigation element manipulator in the closed position 134. Comparing FIG. 13 to FIG. 12 the web navigation element manipulator in the closed position to the left of the label 133 “Bill” in FIG. 12 has changed to a web navigation element manipulator in the open position, shown at 135 in FIG. 13, the closed folder icon 132 before the label 133 “Bill” has changed to an open folder icon 131, and two items in the group of items that starts with “Bill” are now visible at 139 and have the label 133 “Contact info” and “Photo”. The items having the labels “Contact info” and “Photo” are called leaf items 139 because they are not file folders that can be opened to show more items in this same group. Leaf items 139 also do not have any web navigation element manipulators (134 or 135) to the left of the label 133. The web navigation element 130 now displays the first branch 136, the second branch 137, and a third branch, shown at 138. If the web navigation element manipulator in the open position 135 to the left of the label 133 “Bill” in FIG. 13 is clicked, the web navigation element would go back to the shape shown in FIG. 12.

FIG. 14 shows the computer screen 125 after clicking a web navigation element link that generates a pop-up (second) browser window. The label 133 “Contact Info” in FIG. 13 is such a web navigation element link that generates a second browser window and the method was described by the sequence of steps 309, 310, 303, 304, 311, and 313 in FIG. 5. The result of these steps is that a second browser window, shown at 140, is placed on the computer screen 125.

Thus, a method and apparatus for creating an autonomously-alterable navigation web page using a URL link file is disclosed. These specific arrangements and methods described herein are merely illustrative of the principals of the present invention. Numerous modifications in form and detail may be made by those of ordinary skill in the art without departing from the scope of the present invention. Although this invention has been shown in relation to a particular embodiment, it should not be considered so limited. Rather, the present invention is limited only by the scope of the appended claims.

1. A computer-implemented method for creating a user-responsive hierarchical URL link display, the method comprising:
establishing a web browser;
establishing a computer program;
generating fixed format hierarchical URL link data directly from a known data management component;
operating said computer program in said web browser; and
causing the URL link display to occur in response to said computer program and the fixed format URL link data.

2. The method of claim 1 wherein generating further comprises generating multiple records;

3. The method of claim 2 further comprising the step of autonomously exposing additional information in said URL link display in response to user input.

4. The method of claim 3 further comprising the step of establishing a plurality of hierarchy data values in said records.

5. The method of claim 4 further comprising the step of establishing a header record in said hierarchical URL link data wherein said header record comprises data sequence information.

6. The method of claim 5 wherein said known data management component further comprises an electronic spreadsheet program.

7. The method of claim 6 wherein the URL link data further comprises a comma-separated-values format.

8. The method of claim 5 wherein said method further comprises the step of utilizing a client-side program execution engine selected from a group comprising Java, Flash, and JavaScript.

9. The method of claim 5 wherein the URL link display comprises an expandable tree of URL links.

10. The method of claim 5 further comprising the steps of:
establishing style data; and
causing the URL link display to change appearance in response to said style data.

11. The method of claim 5 further comprising the step of encoding said hierarchical URL link data.

12. The method of claim 11 further wherein encoding further comprises data compression.

13. A computer-implemented method for creating a user-responsive hierarchical URL link display, the method comprising:
reading hierarchical URL link data in a web browser; and
sending hierarchical URL link information to a computer screen;
wherein said hierarchical URL link data is in a third-party software direct output format; and
wherein the URL link information can be modified in response to user input.

14. The method of claim 13 wherein reading further comprises reading multiple records.

15. The method of claim 14 wherein the URL link information can be modified autonomously in response to user input.

16. The method of claim 15 further comprising the step of establishing a plurality of hierarchy data values.

17. The method of claim 16 wherein reading further comprises the step of reading a header record in the hierarchical URL link data wherein said header record comprises data sequence information.

18. The method of claim 17 wherein the output format further comprises an electronic spreadsheet output format.

19. The method of claim 18 wherein the electronic spreadsheet output format further comprises a comma-separated-values format.

20. The method of claim 17 wherein said method further comprises the step of utilizing a client-side program execution engine selected from a group comprising Java, Flash, and JavaScript.

21. The method of claim 17 wherein the URL link display comprises an expandable tree of URL links.

22. The method of claim 17 further comprising the step of establishing a style file wherein said style file comprises formatting parameters for the URL link display.

23. The method of claim 17 further comprising the step of encoding the URL link data.

24. The method of claim 23 wherein encoding further comprises data compression.

25. A computer-implemented web page display system, the system comprising:
a web browser;
information processing code;
third-party software fixed output format hierarchical URL link data;
a user-responsive hierarchical URL link display element; and
a computer screen; wherein
said information processing code executes in said web browser; and
said information processing code and said fixed output format URL link data generate the display element in the web page display system on said computer screen.

26. The system of claim 25 wherein the URL link data further comprises multiple records.

27. The system of claim 27 wherein the URL link display element further comprises an autonomous URL link display element.

28. The system of claim 27 wherein said records further comprise a plurality of hierarchy data values.

29. The system of claim 28 wherein the URL link data further comprises a header record and wherein said header record comprises sequence information.

30. The system of claim 29 wherein the fixed output format data further comprises a fixed electronic spreadsheet program output format.

31. The system of claim 30 wherein the fixed electronic spreadsheet program output format further comprises a comma-separated-values format.

32. The system of claim 29 wherein the code further comprises code selected from a group comprising Java, ActionScript, and JavaScript.

33. The system of claim 29 wherein the display element further comprises an expandable URL link tree.

34. The system of claim 29 further comprising style data wherein said style data comprises formatting information for the URL link display element.

35. The system of claim 29 wherein the URL link data further comprises encoded URL link data.

36. The system of claim 35 wherein the encoded URL link data further comprises data-compressed URL link data.

37. A web browser executable information processing code, the code comprising:
a third-party software direct output format hierarchical URL link data interpretation element; and
a user-responsive hierarchical URL link display generation element;
wherein the display generation element responds to the data interpretation element.

38. The code of claim 37 wherein the data interpretation element further comprises a multiple record data interpretation element.

39. The code of claim 38 wherein the display generation element further comprises an autonomous display generation element.

40. The code of claim 39 wherein the data interpretation element further comprises a multiple hierarchy value interpretation element.

41. The code of claim 40 wherein the data interpretation element further comprises a record sequence data interpretation element.

42. The code of claim 41 wherein the URL link data interpretation element further comprises a direct electronic spreadsheet program output format URL link interpretation element.

43. The code of claim 42 wherein the electronic spreadsheet format further comprises a comma-separated-values format.

44. The code of claim 41 wherein said program further comprises code selected from a group comprising Java, ActionScript, and JavaScript.

45. The code of claim 41 wherein the display generation element further comprises an expandable URL link tree display generation element.

46. The code of claim 41 further comprising a style data interpretation element.

47. The code of claim 41 wherein the URL link data interpretation element further comprises an encoded URL link data interpretation element.

48. The code of claim 47 wherein encoded further comprises data compressed.

49. A method for interacting with a hierarchical URL link display, the method comprising:
establishing a web browser;
establishing a computer program;
generating fixed format hierarchical URL link data directly from third-party software;
operating said computer program in said web browser;
causing said hierarchical URL link display to occur in response to said computer program and to said fixed format hierarchical URL link data;
clicking on an element in said hierarchical URL link display; and
exposing further information in response to said clicking.

50. The method of claim 49 wherein generating further comprises generating multiple records.

51. The method of claim 50 wherein said further information comprises elements of said hierarchical URL link data.

52. The method of claim 51 further comprising the step of establishing a plurality of hierarchy data values in said records.

53. The method of claim 52 further comprising the step of establishing a header record in said hierarchical URL link data wherein said header record comprises data sequence information.

54. The method of claim 53 wherein said known data management component further comprises an electronic spreadsheet program.

55. The method of claim 54 wherein the URL link data further comprises a comma-separated-values format.

56. The method of claim 53 wherein said method further comprises the step of utilizing a client-side program execution engine selected from the group comprising Java, Flash, and JavaScript.

57. The method of claim 53 wherein said hierarchical URL link display comprises an expandable tree of URL links.

58. The method of claim 53 further comprising the steps of:
establishing style data; and
causing the URL link display to change its appearance in response to said style data.

59. The method of claim 53 further comprising the step of encoding said hierarchical URL link data.

60. The method of claim 59 wherein encoding further comprises data compression.

61. A method for interacting with a hierarchical URL link display, the method comprising:
establishing a web browser;
establishing a computer program;
generating hierarchical URL link data directly from third-party software;
operating said computer program in said web browser;
causing said hierarchical URL link display to occur in response to said computer program and to said hierarchical URL link data;
placing a cursor in said hierarchical URL link display; and
exposing further information in response to said placing.

62. The method of claim 61 wherein generating further comprises generating multiple records.

63. The method of claim 62 wherein said further information comprises elements of said hierarchical URL link data.

64. The method of claim 63 further comprising the step of establishing a plurality of hierarchy data values in said records.

65. The method of claim 64 further comprising the step of establishing a header record in said hierarchical URL link data wherein said header record comprises data sequence information.

66. The method of claim 65 wherein said known data management component further comprises an electronic spreadsheet program.

67. The method of claim 66 wherein the URL link data further comprises a comma-separated-values format.

68. The method of claim 65 wherein said method further comprises the step of utilizing a client-side program execution engine selected from the group comprising Java, Flash, and JavaScript.

69. The method of claim 65 wherein said hierarchical URL link display further comprises an expandable tree of URL links.

70. The method of claim 65 further comprising the steps of:
establishing style data; and
causing the URL link display to change appearance in response to said style data.

71. The method of claim 65 further comprising the step of encoding said hierarchical URL link data.

72. The method of claim 71 wherein encoding further comprises data compression.

73. A computer-implemented method for using a known data management component to directly generate data values utilized in a user-responsive hierarchical URL link display, the method comprising:
establishing a web browser;
establishing data values in said known data management component;
saving said data values in a fixed format supported by said known data management component and in a location accessible by said web browser;
establishing information processing code in a location accessible by said web browser; and
causing the display to occur in response to the code and the data values.

74. The method of claim 73 wherein establishing further comprises establishing multiple records and wherein said multiple records comprise multiple data values.

75. The method of claim 74 further comprising the step of exposing additional information in the URL link display in response to user input wherein said additional information comprises elements of said data values.

76. The method of claim 75 further comprising the step of establishing a plurality of hierarchy data values in at least one of said multiple records.

77. The method of claim 76 further comprising the step of establishing a header record in said hierarchical URL link data wherein said header record comprises data value sequence information.

78. The method of claim 77 wherein said known data management component further comprises an electronic spreadsheet program and wherein said output format further comprises an electronic spreadsheet program output format.

79. The method of claim 78 wherein said electronic spreadsheet output format further comprises said data values separated by commas.

80. The method of claim 77 wherein establishing code further comprises establishing code from a group comprising Java, ActionScript, and JavaScript.

81. The method of claim 77 wherein the hierarchical URL link display further comprises an expandable tree of URL links.

82. The method of claim 77 further comprising the steps of:
establishing style data; and
causing the URL link display to change appearance in response to said style data.

83. The method of claim 77 further comprising the step of encoding said data values.

84. The method of claim 83 wherein encoding further comprises data compression.
